(19) United States
(12) Patent Application Publication
(10) Pub. No.: US 2007/0110025 A1
(43) Pub. Date: May 17, 2007

(54) Autonomous system interconnect using content identification and validation

(76) Inventors: James N. Guichard, Groton, MA (US); W. Scott Wainner, Potomac Falls, VA (US); Mohammed Sayeed, Shrewsbury, MA (US); Earl Hardin Booth III, Raleigh, NC (US); W. Mark Townsley, Pensacola, FL (US)

Correspondence Address: CHAPIN & HUANG L.L.C.;WESTBOROUGH OFFICE PARK, 1700 WEST PARK DRIVE, WESTBOROUGH, MA, 01581, US

(21) Appl. No.: 11/273,651

(22) Filed: Nov. 14, 2005

(51) Int. Cl. H04L 12/28

(52) U.S. Cl. 370/351

(57) ABSTRACT

A method and computer program product for providing autonomous system interconnect for a first peer device is presented. The method includes producing routing information at a first peer. Next, the first peer device provides a context identifier in the routing information. A context authenticator is also provided in the routing information at the first peer. The first peer then advertises this routing information to a second peer. The first peer only accepts messages from the second peer which include the context identifier and the context authenticator.

### BACKGROUND

Before discussing the present invention, certain terms, used throughout the description, will be defined.

An Autonomous System Border Router (ASBR) is a router located on an edge of an autonomous system and functions as an autonomous system's link to other routing domains. The ASBR exchanges router information with routers belonging to other routing domains. Such a router has AS external routes that are advertised throughout the autonomous system. The path to each ASBR is known to every other router in the autonomous system.

Routers support Virtual Routing and Forwarding instances (VRFs). A VRF includes a network address routing table, a derived forwarding table, a set of interfaces that use the forwarding table, and a set of rules and routing protocols that determine what goes into the forwarding table.

A Virtual Private Network (VPN) is a network that uses a public telecommunication infrastructure, such as the Internet, to provide remote offices or individual users with secure access to their organization's network. A VPN works by using the shared public infrastructure while maintaining privacy through security procedures and tunneling protocols.

Multi-Protocol Border Gateway Protocol (MPBGP) is an exterior gateway routing protocol that enables groups of routers to share routing information so that efficient, loop-free routes can be established.

Multi-Protocol Label Switching (MPLS) is a standards-approved technology that involves setting up a specific path for a given sequence of packets, identified by a 20 bit label put in each packet.

A Service Level Agreement (SLA) is a contract between a network service provider and a customer that specifies, usually in measurable terms, what services the network service provider will furnish. Many Internet service providers (ISP)s provide their customers with an SLA. More recently, IS departments in major enterprises have adopted the idea of writing a service level agreement so that services for their customers (users in other departments within the enterprise) can be measured, justified, and compared with those of outsourcing network providers.

On the Internet and in other networks, QoS (Quality of Service) is the idea that transmission rates, error rates, and other characteristics can be measured, improved, and, to some extent, guaranteed in advance. QoS is of particular concern for the continuous transmission of high-bandwidth video and multimedia information. Transmitting this kind of content dependably is difficult in public networks using ordinary “best effort” protocols. Using the Internet's Resource Reservation Protocol (RSVP), packets passing through a gateway host can be expedited based on policy and reservation criteria arranged in advance. Using ATM, which also lets a company or user preselect a level of quality in terms of service, QoS can be measured and guaranteed in terms of the average delay at a gateway, the variation in delay in a group of cells (cells are 53-byte transmission units), cell losses, and the transmission error rate.

A Label Forwarding Information Base (LFIB) is a subset of a Label Information Base (LIB). The LFIB contains an incoming label, an outgoing label, a next hop and an outgoing interface. The LFIB contains what is actually being used to forward packets via label swapping, whereas the LIB contains all possible routes (generated by the underlying routing Link State Protocol) with labels already assigned. The LFIB has only labels and interface information, with no IP information. The LIB has IP information, label and interface information, and an indication of which is the shortest path to the given destination. Any route in the LFIB will also be in the LIB, but not the other way around.

The industry has standardized on a few Inter-Autonomous System (AS) models that the service providers may deploy. The current industry standards for Inter-AS solutions include the models defined as 10a, 10b, and 10c.

The first model defined and deployed by many service providers is the 10a model. The 10a model requires the provider to build on their ASBR a VRF per VPN, a unique peering interface per VRF, and a unique routing process per VRF. The peer ASBR does the same thereby creating a one-for-one relationship between the two ASBR's. The advantages of the 10a model include discrete interfaces facilitating QoS mechanisms and explicit resource management methods that protect the memory and processing resources. Likewise, the exposure of the ASBR and the attached network is limited.

The second model defined and deployed by a few service providers is the 10b model. The 10b model only requires the provider to build a single interface for each peer and a single routing process on the interface. The routing process (MP-BGP) is able to maintain the segregation of VPN prefixes without having to use discrete VRF's per enterprise VPN. The advantages include less memory consumption for the routing prefixes and interfaces, less processor consumption for the routing process, and automatic VPN session binding between the ASBR's.

The third model defined and rarely deployed by service providers is the 10c method. The 10c model only requires the provider to build a single interface for each peer and a single routing process on the interface. A routing process (MP-BGP) is able to maintain the segregation of VPN prefixes without requiring a presence on the ASBR. The advantages include even less memory consumption for the routing prefixes since the VPN prefixes are passed around the ASBR. The ASBR has even less processor consumption since the ASBR serves as a core device providing connectivity between the two AS's.

The two most commonly used models—10a and 10b—have orthogonal capabilities. Where 10a is strong, 10b is weak and vice-a-versa. Table 1 provides a synopsis of the existing solutions.

TABLE 1

| ASBR | 10a | 10b | 10c |
|---|---|---|---|
| Routing | Many | One | One |
| Interfaces | Many | One | One |
| Memory | Per-prefix | Per-label | Per-label |
| QoS | Per-VPN | Global | Global |
| Configuration | Manual | Dynamic | Dynamic |
| Resource | Strong | Weak | Weak |
| Security | Strong | Weak | Very Week |

Routing processes are complex state machines that keep track of the prefixes and the paths to reach the prefixes. Routing processes can be constrained by a number of factors such as the number of peers or adjacencies, the number of routing entries, and the number of potentially viable paths for each routing entry. As the number of prefixes and interfaces increase, the computation complexity increases thereby requiring more processor schedule time. Excessive computational routing complexity on the ASBR may impact any or all the VPN's. As shown in Table 1, the 10a method requires many routing processes, while the 10b and 10c methods require a single routing process.

Interfaces consume memory constructs and typically require an operator to configure the interface and the associate peer entity. The cost of a VPN interface is usually not too cumbersome in an Inter-AS solution as the number of VPNs is typically small. Nevertheless, the interface must be created and correctly associated with the appropriate customer. The 10a method requires many interfaces, while the 10b and 10c methods require a single interface.

Memory is allocated for VPN prefixes. VPN prefixes can create a resource burden on the ASBR. The number of prefixes is not directly controlled by a single provider or customer, but by the aggregate set of operators and customers. For this reason, memory allocated for VPN prefixes may be very precious. The 10a method requires memory on a per-prefix basis, while the 10b and 10c methods require memory on a per-label and per-prefix basis.

The customers of the MPLS VPN are particularly interested in QoS, especially at provider boundaries where SLA's tend to be difficult to enforce. Each enterprise has unique QoS requirements that may be difficult to handle in aggregate; however, provisioning a QoS model per customer is also a challenge especially when there is no discrete point where the QoS model may be applied. The 10a method allows QoS on a per-VPN basis, whereas the 10b and 10c methods only allow QoS on a global basis.

The Inter-AS model requires a configuration that establishes a relationship between the ASBR's for each VPN. The configuration should be simple to implement and should be easy to replicate. All methods require manual configuration, either through CLI or a management tool, although 10a has additional configuration burden due to the number of VRFs/interfaces required.

Resources (memory, interfaces, and processor schedule time) are precious for a service provider. In particular, the provider is interested in conducting “One Time Provisioning” for many services. In addition, the management of the allocated resources can become a burden. To minimize the Operation Expenditures, the provider will frequently over-provision many of the components in a solution if the Capital Costs of the components are negligible. On the contrary, the expensive components are monitored closely and judiciously allocated. Resource management plays a critical role insuring SLA's are met. The 10a method provides strong resource management, while the 10b and 10c methods provide weak resource management.

Closely related with resource management is security. Security requirements permeate the solution such that the provider can protect their assets, their ability to provide services, as well as one customer from another customer. Security is based on a risk management model where the law of diminishing returns plays a critical role. The cost of security (capital costs, functional costs, operational costs) must be balanced against the potential risk (liability costs, credibility, etc.). Clearly, failure to address the security requirements of a solution makes the previous points highlighted somewhat pointless. The 10a method provides for strong security, while the 10b method provides weaker security and the 10c method provides even weaker security than the 10b method.

### SUMMARY

Conventional mechanisms such as those explained above suffer from a variety of deficiencies. One such deficiency is that the conventional 10a model consumes more resources on the ASBR which limits the scalability of the model. Resources include establishment of routing entries, interfaces, and routing processes. Routing entries and interfaces consume memory while routing processes consume processing resources. In addition, each of the constructs must be manually configured per customer.

Regarding the 10b model, the single interface exposes the ASBR (and the attached provider network) to the peer network and their customers. There is no distinct point of enforcement for applying resource management and QoS mechanisms on a per customer basis.

Regarding the 10c model, the single interface exposes the ASBR and the entire attached provider network to the peer network. There is no distinct point of enforcement for applying resource management and QoS mechanisms on a per customer basis. This model has been deemed insecure for Inter-provider Inter-AS solutions.

Embodiments of the invention significantly overcome such deficiencies and provide an autonomous system interconnect using content identification and validation techniques that address the scalability, security and resource management issues associated with known environments.

In a particular embodiment of a method for providing autonomous system interconnect for a first peer device, the method includes producing routing information at a first peer. Next, the first peer device provides a context identifier in the routing information. A context authenticator is also provided in the routing information at the first peer. The first peer then advertises this routing information to a second peer. The first peer only accepts messages from the second peer which include the context identifier and the context authenticator.

In another particular embodiment of a method for providing autonomous system interconnect for a peer device, the method receiving routing information from a first peer at a second peer, the routing information including a context identifier and a context authenticator. The method further includes transmitting messages which include the context identifier and the context authenticator from the second peer to the first peer.

In yet another particular embodiment of a method for providing autonomous system interconnect for a pair of peer devices, the method includes producing routing information at a first peer. The method further includes and providing a context identifier in the routing information at the first peer and providing a context authenticator in the routing information at the first peer. The first peer then advertises the routing information to a second peer. The second peer receives the routing information from the first peer, the routing information including the context identifier and the context authenticator. The second peer transmits messages to the first peer which include the context identifier and the context authenticator. The first peer only accepts messages from the second peer which include the context identifier and the context authenticator.

Other embodiments include a computer readable medium having computer readable code thereon for providing an autonomous system interconnect, the medium including instructions for producing routing information at a first peer. The medium further includes instructions for providing a context identifier in the routing information at the first peer, as well as instructions for providing a context authenticator in the routing information at the first peer. Additionally the medium includes instructions for advertising, from the first peer, the routing information to a second peer. The medium further includes instructions for receiving routing information from the first peer at the second peer, the routing information including the context identifier and the context authenticator. The medium also includes instructions for transmitting messages from the second peer which include the context identifier and the context authenticator to the first peer and instructions for accepting, at the first peer, messages from the second peer which include the context identifier and the context authenticator.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides an autonomous system interconnect using content identification and validation as explained herein that when performed (e.g. when executing) on the processor, operates as explained herein within the computerized device to perform all of the method embodiments and operations explained herein as embodiments of the invention. Thus any computerized device that performs or is programmed to perform up processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing an autonomous system interconnect using content identification and validation as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device. The features of the invention, as explained herein, may be employed in data communications devices and/or software systems for such devices such as those manufactured by Cisco Systems, Inc. of San Jose, Calif.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a prior art 10a model for inter-AS solutions;

FIG. 2 illustrates a prior art 10b model for inter-AS solutions;

FIG. 3 illustrates a first embodiment of an autonomous system interconnect using context identification and validation in accordance with embodiments of the present invention;

FIG. 4 illustrates a second embodiment of an autonomous system interconnect using context identification and validation in accordance with embodiments of the present invention;

FIG. 5 illustrates a third embodiment of an autonomous system interconnect using context identification and validation in accordance with embodiments of the present invention;

FIG. 6 illustrates a fourth embodiment of an autonomous system interconnect using context identification and validation in accordance with embodiments of the present invention;

FIGS. 7A and 7B comprises a flow diagram of a particular method of providing autonomous system interconnect using context identification and validation in accordance with embodiments of the present invention; and

FIG. 8 comprises a flow diagram of another particular method of providing autonomous system interconnect using context identification and validation in accordance with embodiments of the present invention; and

FIGS. 9A and 9B comprises a flow diagram of yet another particular method of providing autonomous system interconnect using context identification and validation in accordance with embodiments of the present invention.

### DETAILED DESCRIPTION

The proposed architecture for providing autonomous system interconnect using context identification and validation improves the security of the 10b model while avoiding completely reverting back to the 10a model. In general, the 10a and 10b solutions can be described as follows: the 10a solution doesn't scale but provides security and resource management, while the 10b solution scales well but doesn't allow viable security or resource management methods. As a result, providers have predominately deployed the 10a model.

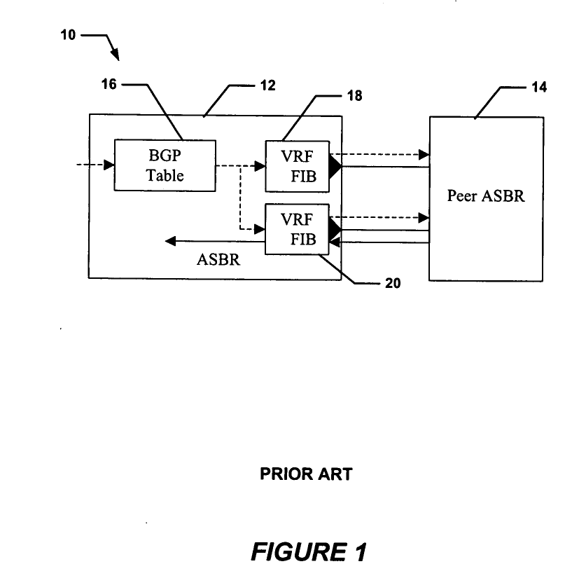

Referring now to FIG. 1, the 10a model 10 is shown. In this environment, a first ASBR 12 (also referred to as a first peer) is shown in communication with a second ASBR 14 (also referred to as a second peer). ASBR 12 is shown including a BGP table 16, a first VRF FIB 18 and a second VRF FIB 20, all in communication with each other.

Each customer has a VRF FIB that controls the amount of memory allocated for that customer's IP route prefixes. This facilitates explicit resource allocation. The BGP process and memory allocation is protected by controlling the number of prefixes received from the Peer ASBR 14 via each VRF's control plane.

The prefixes (e.g., VPNv4 prefixes) are converted at the first ASBR 12 into IP prefix entries in FIB. This includes prefixes sent to the ASBR 14 as well as prefixes received from ASBR 14. The conversion consumes memory resources and processing resources.

The interfaces between the ASBRs 12 and 14 are connected to the VRF FIB 18 and 20 as opposed to the ASBR's global FIB (not shown). Each interface facilitates a discrete point where security and resource functions may be applied. The VRF FIB 18 and 20 and associated interfaces consume resources on the ASBR on a per customer basis.

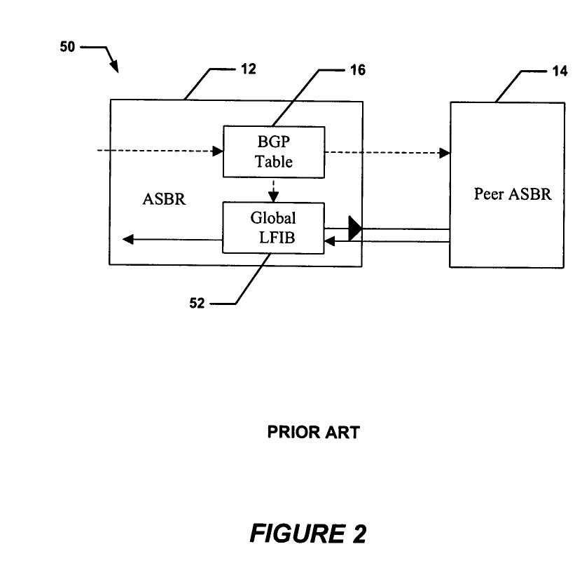

Referring now to FIG. 2, the 10b model 50 is shown. In this environment, the first ASBR 12 is shown in communication with the second or peer ASBR 14. ASBR 12 is shown including a BGP table 16, and a Global LFIB 52 in communication with BGP table 16.

In this model 50 all the VPN's use the same control plane for exchanging prefixes. The resource allocation and security of the control plane can only accommodate global resource constraints which do not facilitate protection of a customer or the services viability. The VPNv4 prefixes are only relayed from the BGP table.

The interfaces between the peers 12 and 14 are connected to the ASBR's global FIB (e.g. there are no VRF interfaces in this model). The application of QoS and security mechanism are applicable to the global forwarding context as opposed to the VPN context.

There are a couple of options that would serve as compromises between the two viable service models described above (discarding 10c as viable). If an architectural modification is made to the 10b model, the security aspects of the solution must be scrutinized. The incoming data flows from the peer should be validated. It should be noted that validation does not concern validating or authenticating data received from the peer; but instead validating the context of data flows received from the peer. Establishing an authenticated, even encrypted, session with a peer ASBR doesn't validate the context of the data received from the peer. The objective of the authenticated flow context is to receive a frame from a peer and have a high degree of confidence that the frame is valid, that is, from the correct peer, with the appropriate destination, and with the proper context. Simply receiving an IP frame or label encapsulated IP frame provides the receiving ASBR insufficient information to validate the frame. The receipt of an IP frame on a global interface doesn't provide enough information to associate the frame with a customer. The receipt of a label-encapsulated frame doesn't provide enough information to discern the validity of the sending ASBR, nor does it provide enough information to discern if the labeled frame was sent in the correct context (i.e. a specific customer's L3VPN labeled frame verses FRR, TE, or AToM).

In one embodiment, the prior inability to validate the frame received from the peer is reconciled by advertising an authenticator value to the peer such that return traffic from the peer ASBR uses the authenticator in the data frame. Again, this is not authenticating all data from a peer, but authenticating the context of data flows from the peer.

Specifically, the first peer advertises a set of private IP routes, their associated labels, and the first peer's next-hop. In order to insure that the second peer is a valid sender of data to the first peer, the first peer also advertises a session ID and a cookie associated with the set of private prefixes. The Session ID provides context for the first peer to validate the received frames and the Cookie provides an authenticator value. Alternatively, the first peer may advertise a two label stack associated with the set of private prefixes bound to the VPN label. The first label in the stack provides the context for the first peer to validate while the second label in the stack provides an authenticator value. Only the second peer is privileged to receive the two elements via a control plane established with the first peer. In either case, the subsequent field in the stack represents the VPNv4 label used to identify the VPN.

These two values are referred to as a ‘Context Identifier’ and ‘Context Authenticator’. By authenticating peers to whom the context identifier and context authenticator (i.e. control plane authentication) are sent, then there is a high degree of confidence that frames received with the proper context and valid authenticator are in fact valid frames.

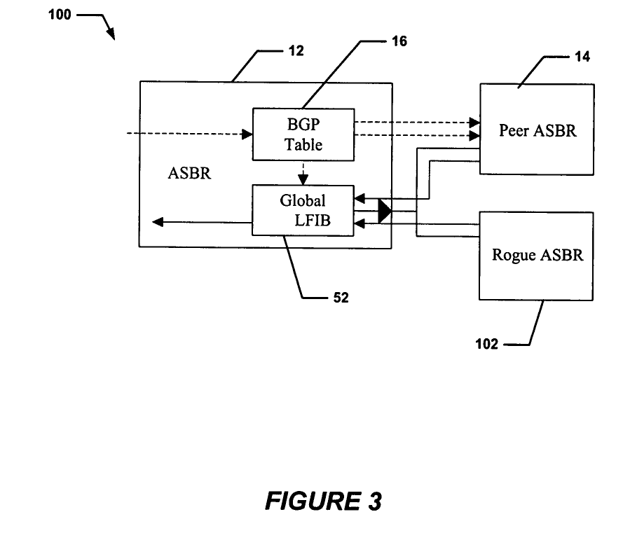

The modifications to the 10b model continue to use the existing label swap functionality as previously defined; however, the validity of labels is bounded by ‘context identifier’. FIG. 3 shows the relationship for this environment.

Referring now to FIG. 3, the environment 100 is shown. In this environment, the first ASBR 12 is shown in communication with the second peer ASBR 14. ASBR 12 is shown including a BGP table 16, and a Global LFIB 52 in communication with BGP table 16. Also shown is a rogue ASBR 102 in communication with the first ASBR 12 and the peer ASBR 14. In this environment the ASBR (e.g. ASBR 12) is able to select a ‘context identifier’ (e.g. Session ID for L2TPv3, or context label for MPLS) for a particular peer (e.g. ASBR 14) and/or VPN from which the ASBR expects to receive frames. Upon receipt of the data frames from the peer ASBR 14, the ASBR 12 is able to look up the context of the frame and determine if the appropriate peer sent the frame. Likewise, the ASBR may validate the frame using the authenticator in the encapsulation header. Once the frame has been validated, the encapsulation header (i.e. L2TPv3 Session ID and Cookie, or MPLS two-label stack) may be removed such that only the VPNv4 labeled frame remains. The remaining VPNv4 labeled frame may continue to use the global LFIB for swapping to reach the appropriate PE's VRF for L3VPN switching.

In the case where an attempt to send messages from rogue ASBR 102 is encountered, since ASBR 12 did not select a context identifier for the rogue ASBR 102, any messages received from rogue ASBR 102, do not contain the proper context identifier, and are therefore dropped.

In this environment 100, the first ASBR is able to establish a per-peer MP-BGP relationship that is authenticated. This allows the sending of the ‘Context Identifier’ and ‘Context Authenticator’ to a trusted entity that the ASBR will receive data frames from. There are several options for providing varying degrees of risk management:

The Context Identifier and the Context Authenticator can be used on a Per-Peer basis. A unique ‘context identifier’ and associated ‘context authenticator’ is sent to each peer. This insures that the ASBR is receiving frames from the appropriate peer.

The Context Identifier and the Context Authenticator can be used on a Per-VPN basis. A unique ‘context identifier’ and associated ‘context authenticator’ is sent per VPN to any peer. This insures that the ASBR is receiving frames for the proper VPN; however, it doesn't validate the peer.

The Context Identifier and the Context Authenticator can be used on a Per-Peer Per-VPN basis. A unique ‘context identifier’ and associated ‘context authenticator’ is sent to each peer for each VPN. This insures that the ASBR is receiving frames for the proper VPN from the proper peer.

The Context Identifier and the Context Authenticator can be used on a Per-peer Next-hop basis. The first ASBR 12 specifies that a given peer use a specific IP next-hop for a VPN IP encapsulation. This may facilitate an additional level of control since the some VPN's may require confidentiality that is not provided by the ‘context authenticator’. In this case, IPSec may be used to protect the data flow between the ASBRs where they are not directly connected.

The previous description facilitated the validation of frames from the peer and/or VPN; however, it does not provide any granular control of resources populating the global LFIB. In the same way that a first ASBR is advertising VPN prefixes to the peer ASBR, the peer ASBR is advertising prefixes to the first ASBR. One of the security considerations is the requirement to protect memory resources and processing requirements. The current Inter-AS 10b model uses a single MP-BGP peering session. Within the VPNv4 address family, there are no means of controlling the number of prefixes received on a per-customer basis.

One method of controlling the number of prefixes received from the peer ASBR is to bound the memory space allocated to the VPN. This is accomplished in the Inter-AS 10a model by only accepting a certain number of prefixes for the VRF associated with the customer. The identification of customer prefixes is determined by the specific routing adjacency with the peer ASBR (e.g. unique OSPF process or address family for BGP, EIGRP, or RIP). In the 10b model, there is no means of automatically identifying a customer's set of prefixes in the global LFIB. Each VPN prefix is tagged with the BGP next-hop, the Route Distinguisher (RD), and one or more Route Targets (RT). The BGP next-hop is not unique per customer and an administrative domain operator frequently uses multiple RD's for a single MPLS VPN customer. The only element that may uniquely define a customer's set of prefixes is the RT. The approach to bounding the set of VPN prefixes is to allocate memory for the customer's set of prefixes and to populate the memory by matching a subset of the RT values received via the BGP VPNv4 updates. A potential technique for accomplishing this is to partition the LFIB space on a per customer basis. The ASBR will receive VPNv4 prefixes, match those with a specified RT value for a given VPN LFIB memory allocation, and build a VPNv4 label switching entry in the partitioned LFIB. This prevents excessive VPN prefixes received from the peer ASBR from consuming a local ASBR's memory. The memory partition for a single VPN might be exhausted; however, the problem is contained to this individual VPN.

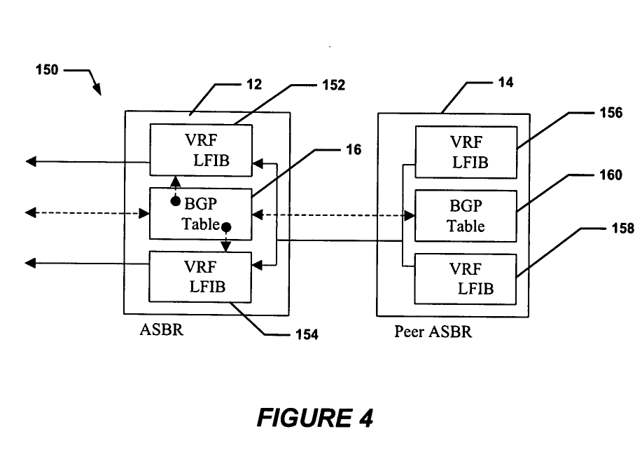

In the environment 150 shown in FIG. 4 peer ASBR 14 is shown having a first VRF LFIB table 156, a second VRF LFIB table 158, and a BGP table 160. The flows from the peer ASBR 14 are arriving on a common interface. By allocating a unique “context identifier” per VRF LFIB 152 and 154 (represented by a Session ID if L2TPv3 is used or a VRF LFIB stacked label), the ASBR 12 is able to receive packets from the peer ASBR 14 on a shared interface and identify which VRF LFIB 152 or 154 is appropriate for the label swap. This provides a means of controlling the amount of memory a peer ASBR 14 consumes on an ASBR 12 and provides a means of identifying the partitioned memory upon receipt of data from the peer ASBR 14.

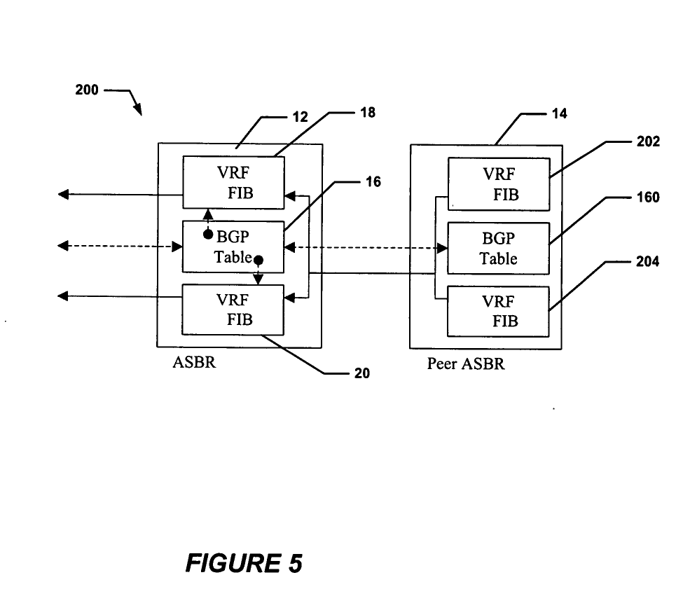

Referring now to FIG. 5, an environment 200 is shown wherein each ASBR 12 and 14 include a pair of VRF FIBs 18, 20 and 206 and 208 respectively. An alternative to the VRF LFIB of FIG. 4, is to transition the VPNv4 prefixes to a partitioned VRF FIB 18 and 20 as shown in the model environment 200 of FIG. 5. This requires an IP lookup upon receipt of packets from the peer ASBR 14 as opposed to a VPNv4 label swap.

The last stage of processing is to route the IP packet. The VRF FIB 18 or 20 may consume more memory than a VRF LFIB; however, there are advantages to use the VRF FIB. In particular, since an IP packet is being used, IP based services can be applied. This is important since the VRF FIB or LFIB partition only protects the ASBR's memory allocation; it doesn't protect the VPN data flows transitioning through the ASBR nor does it protect the forwarding resources allocated to a particular VPN's data flow.

It is further desirable to protect the forwarding resources of the ASBR. The common interface on the ASBR allows the rate of packets sent and received to the peer ASBR to be controlled; however, it doesn't provide a means of protecting the flows through the ASBR on a per VPN basis. The ASBR is an entry point in the network which presents inherent vulnerabilities. It is advisable to protect the administrative domain at this point rather than try to protect the network after the rogue or excessive flows fan-out through the network. The data flows associated with an individual VPN customer cannot be distinguished in the aggregated flow model of 10b. If one of the customers exceeds their contractual allotted capacity, there is no way to rate limit the customer's data flow. This might be particularly important where one customer's VPN is infected with a virus such that the one VPN effectively induces a Denial of Service by consuming all the forwarding resources on the ASBR. Ideally, the ability to prioritize packets leaving the administrative domain on the ASBR link and to shape the flows to insure contractual compliance are required. Likewise, it is also desirable to rate-limit a specific VPN's flow into the administrative domain. There's no enforcement point on ASBR link that adequately identifies a specific VPN's data flow rate.

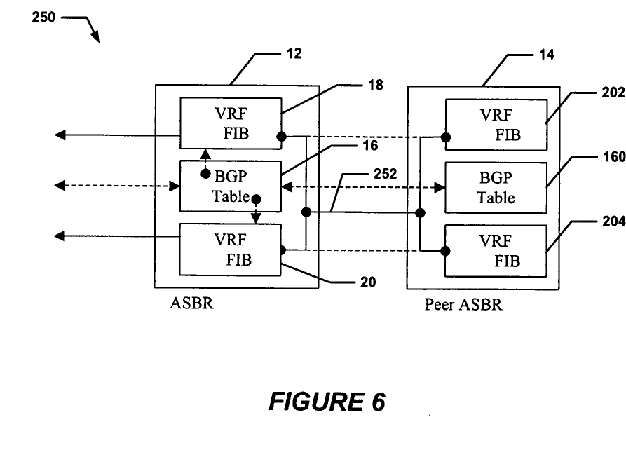

One solution is to augment the VRF FIB on the ASBR with a virtual interface. The virtual interface is configured as an ingress/egress interface in the VRF while the packet flow into and out of the VRF uses the shared ASBR link for transmitting to and receiving from the peer ASBR. FIG. 6 demonstrates the concept of the virtual interface.

One method for achieving such a communication channel with the peer ASBR's VRF FIB 18 or 20 is to build a Generic Route Encapsulated (GRE) tunnel 252 between the VRFs where the GRE tunnels use the ASBR's shared link as the tunnel source and destination. There are a couple of difficulties when using this model.

First, the GRE tunnel interface must specify a tunnel IP source and destination. The tunnel IP source/destination pair must be unique for each of the VRF's. This creates an administrative burden on the operator since these addresses must be assigned on the ASBR's shared like to the peer. This problem can be alleviated by using L2TPv3 since the “context identifier” represented by the L2TPv3 Session ID provides sufficient information for the ASBR to associate data flows with the proper VRF.

The second problem with the typical tunnel interface is that a dedicated routing process is required within the VRF. It is desirable to leverage the common MP-BGP process that is exchanging VPNv4 prefixes with the peer ASBR for all the VPN's. The behavior of the ASBR is modified by creating a VRF routing entry pointing to the VRF's virtual interface upon importation of the VPNv4 prefixes into the VRF. This process of building the virtual interface can be automated through the MP-BGP capability exchange between the ASBR's. Each ASBR would announce the presence of a VPN “context identifier” through the address family associated with the VRF. It would also install the virtual interface. Upon receipt of VPNv4 routing prefixes from the peer ASBR 14, the ASBR 12 now has sufficient information for encapsulation and transmittal to the peer ASBR 14. Likewise, the ASBR 12 can signal the appropriate attributes to the peer ASBR 14 such that decapsulation may occur in a secure manner. The presence of the virtual interface provides a discrete point upon which QoS mechanisms can be applied. Classification, marking, and queuing mechanisms can be applied when transmitting into the virtual interface. Likewise, classification, marking, and rate limiting can be performed for traffic received on the virtual interface.

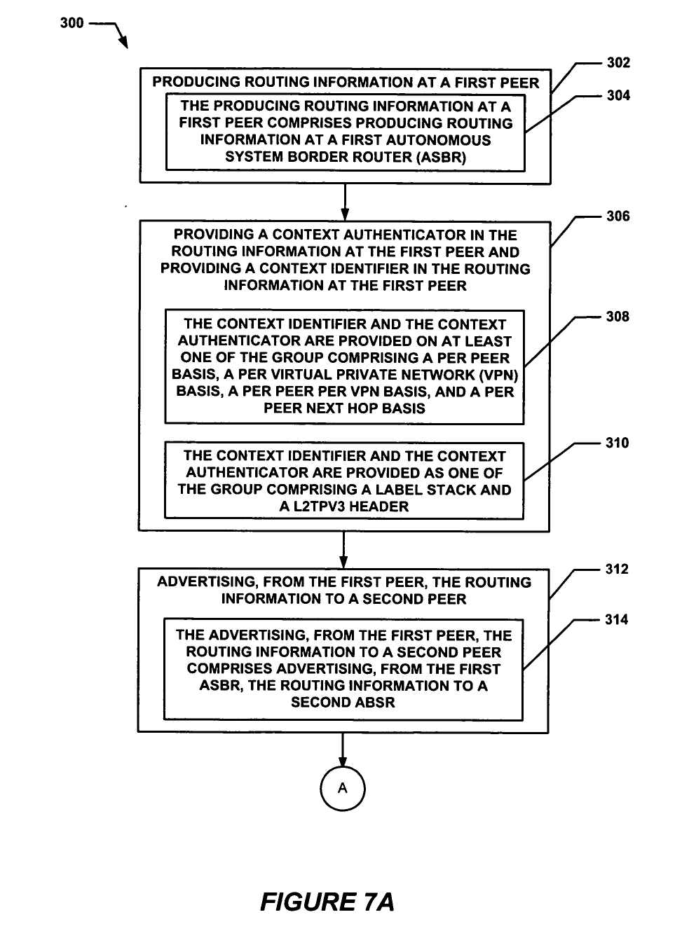

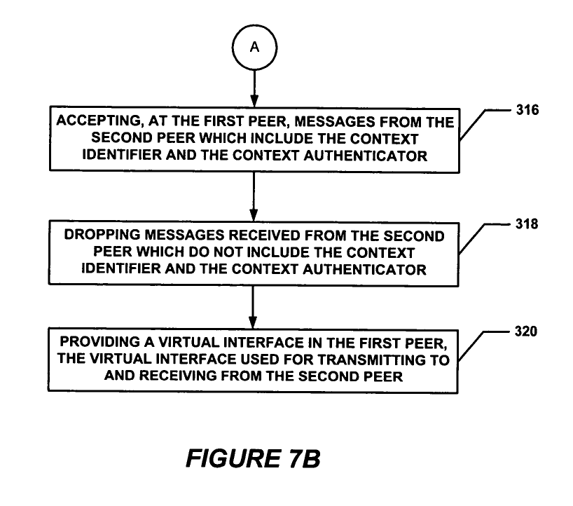

Flow charts of the presently disclosed methods are depicted in FIGS. 7A-9B. The rectangular elements are herein denoted “processing blocks” and represent computer software instructions or groups of instructions. Alternatively, the processing blocks represent steps performed by functionally equivalent circuits such as a digital signal processor circuit or an application specific integrated circuit (ASIC). The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIGS. 7A and 7B, a method 300 of providing autonomous system interconnect at a first peer is shown. The method 300 begins with processing block 302 wherein routing information is produced at a first peer. As shown in processing block 304, the producing of routing information is performed at a first autonomous system border router (ASBR).

In processing block 306, a context identifier is provided in the routing information at the first peer, as is a context authenticator. As recited by processing block 308, the context identifier and the context authenticator are provided on at least one of the group comprising a per peer basis, a per Virtual Private Network (VPN) basis, a per peer per VPN basis, and a per peer next hop basis. As further recited in processing block 310, the context identifier and the context authenticator are provided as one of the group comprising a two-label stack or a L2TPv3 header.

In processing block 312 the first peer advertises the routing information to a second peer. As shown in processing block 314, the advertising the routing information to a second peer comprises advertising, from the first ASBR, the routing information to a second ABSR.

As shown in processing block 316, the first peer accepts messages from the second peer which include the context identifier and the context authenticator. As recited in processing block 318, the first peer drops messages received from the second peer which do not include the context identifier and the context authenticator.

In processing block 320 a virtual interface is provided in the first peer. The virtual interface is used for transmitting to and receiving from the second peer.

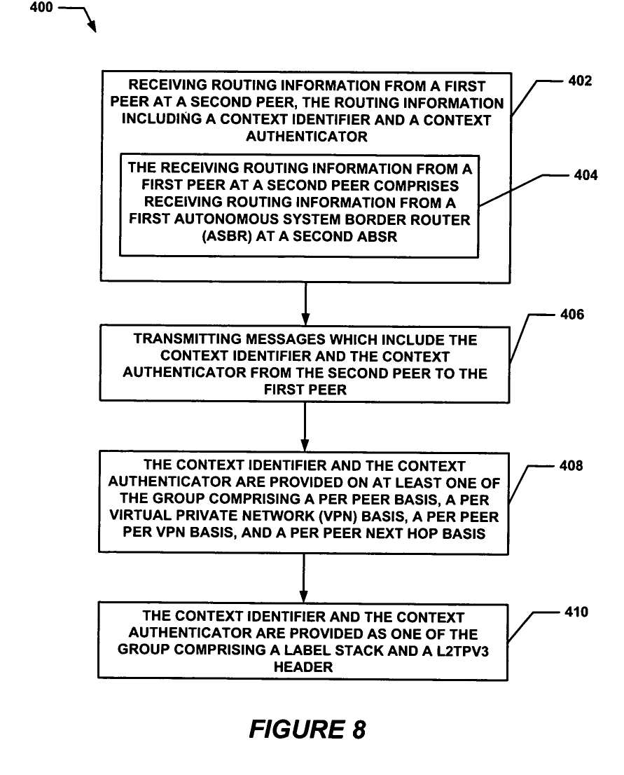

Referring now to FIG. 8, a particular embodiment of a method of providing autonomous system interconnect at a second peer in a multi-peer system is shown. The method 400 starts with processing block 402 wherein routing information is received at the second peer from a first peer. The routing information includes a context identifier and a context authenticator. In processing block 404, the receiving routing information from a first peer at a second peer comprises receiving routing information from a first Autonomous System Border Router (ASBR) at a second ASBR.

In processing block 406 the second peer transmits messages which include the context identifier and the context authenticator from the second peer to the first peer.

As recited by processing block 408, the context identifier and the context authenticator are provided on at least one of the group comprising a per peer basis, a per Virtual Private Network (VPN) basis, a per peer per VPN basis, and a per peer next hop basis.

As shown in processing block 410 the context identifier and the context authenticator are provided as one of the group comprising a two-label stack or a L2TPv3 header.

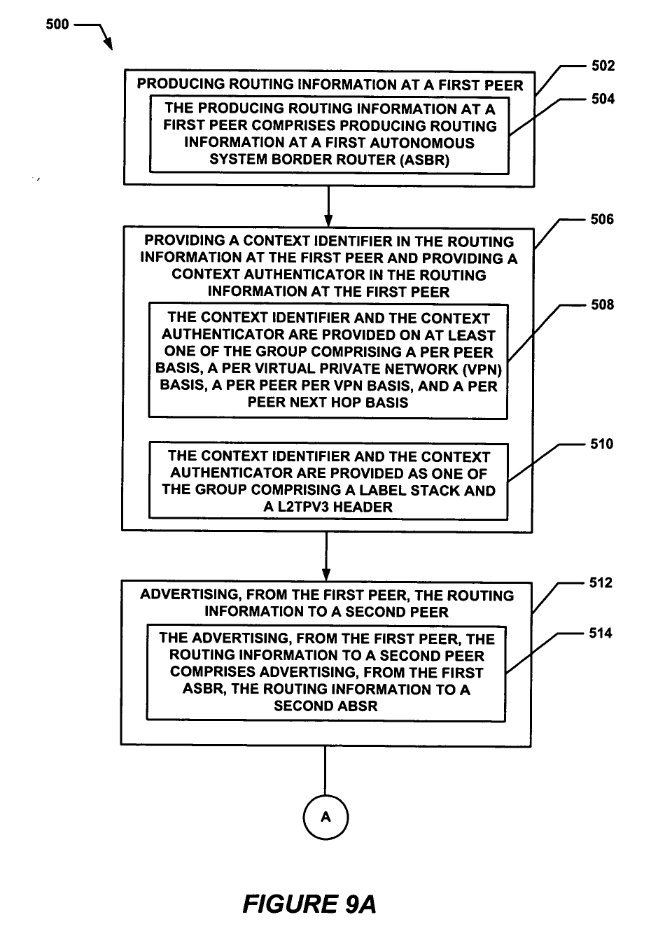

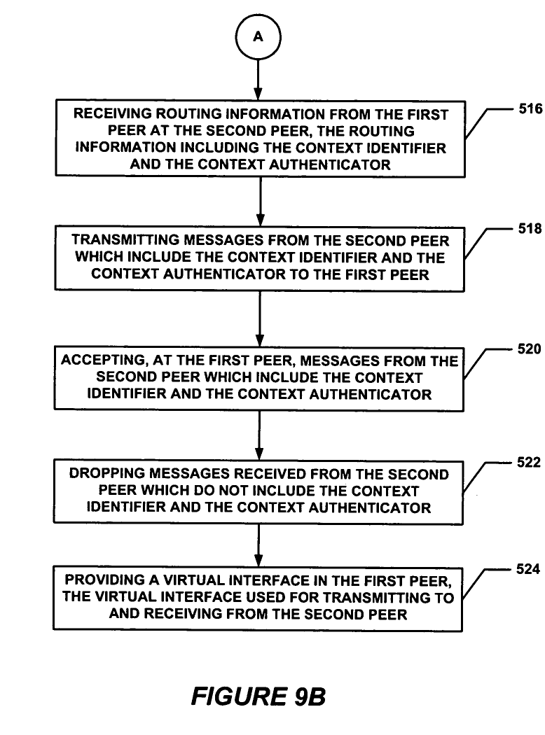

Referring now to FIGS. 9A and 9B, a method of providing autonomous system interconnect for a system 500 is shown. The method 500 begins with processing block 502 wherein routing information is produced at a first peer. As shown in processing block 504, producing routing information at a first peer comprises producing routing information at a first Autonomous System Border Router (ASBR).

In processing block 506, a context identifier is provided in the routing information at the first peer, as is a context authenticator. As recited by processing block 508, the context identifier and the context authenticator are provided on at least one of the group comprising a per peer basis, a per Virtual Private Network (VPN) basis, a per peer per VPN basis, and a per peer next hop basis. As further recited in processing block 510, the context identifier and the context authenticator are provided as one of the group comprising a two-label stack or a L2TPv3 header.

In processing block 512 the first peer advertises the routing information to a second peer. As shown in processing block 514, the advertising the routing information to a second peer comprises advertising, from the first ASBR, the routing information to a second ABSR.

In processing block 516 the routing information is received at the second peer from the first peer. The routing information includes a context identifier and a context authenticator. In processing block 518 the second peer transmits messages which include the context identifier and the context authenticator from the second peer to the first peer.

As shown in processing block 520, the first peer accepts messages from the second peer which include the context identifier and the context authenticator. As recited in processing block 522, the first peer drops messages received from the second peer which do not include the context identifier and the context authenticator.

In processing block 524 a virtual interface is provided in the first peer. The virtual interface is used for transmitting to and receiving from the second peer.

Referring back to Table 1 the various characteristics of the different conventional methods are shown. The 10a has many negative qualities and few neutral or positive qualities. The dominant model in use today is the 10a method despite all of its shortcomings. This is primarily predicated on the presence of strong resource and QoS controls. The 10b model is rarely deployed even though it has many positive qualities. It is missing the fundamental requirements of Resource and QoS control mechanisms. The presently disclosed method of using a partitioned VRF_LFIB improves upon the security characteristics somewhat. The additional alternative of using a partitioned VRF_FIB with Virtual Interfaces makes substantial improvements in the Resource and QoS control mechanisms. There are substantial improvements over the 10a model for enhanced scalability. A summary is shown below in Table 2

TABLE 2

| | | | | VRF | VRF |
|---|---|---|---|---|---|
| ASBR | 10a | 10b | 10c | LFIB | FIB-VI |
| Routing | Many | One | One | One | One |
| Interfaces | Many | One | One | One | Many |
| Memory | Per-prefix | Per-label | Per-label | Per-label | Per-prefix |
| QoS | Per-intf | Aggregate | Aggregate | Aggregate | Per-intf |
| Auto- | Manual | Dynamic | Dynamic | Dynamic | Dynamic |
| Config | | | | | |
| Resource | Strong | Weak | Weak | Medium | Strong |

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carries thereon as digital or analog signals. Accordingly, it is submitted that the invention should be limited to the described embodiments but rather should be limited only by the spirit and scope of the appended claims.

What is claimed is:

1. A method of providing autonomous system interconnect comprising:
producing routing information at a first peer;
providing a context identifier in said routing information at said first peer;
providing a context authenticator in said routing information at said first peer;
advertising, from said first peer, said routing information to a second peer; and
accepting, at said first peer, messages from said second peer which include said context identifier and said context authenticator.

2. The method of claim 1 further comprising dropping messages received from said second peer which do not include said context identifier and said context authenticator.

3. The method of claim 1 further comprising providing a virtual interface in said first peer, said virtual interface used for transmitting to and receiving from said second peer.

4. The method of claim 2 wherein said context identifier and said context authenticator are provided on at least one of the group comprising a per peer basis, a per Virtual Private Network (VPN) basis, a per peer per VPN basis, and a per peer next hop basis.

5. The method of claim 4 wherein said context identifier and said context authenticator are provided as one of the group comprising a two-label stack or a L2TPv3 header.

6. The method of claim 1 wherein said producing routing information at a first peer comprises producing routing information at a first Autonomous System Border Router (ASBR), and wherein said advertising, from said first peer, said routing information to a second peer comprises advertising, from said first ASBR, said routing information to a second ABSR.

7. A method of providing autonomous system interconnect comprising:
receiving routing information from a first peer at a second peer, said routing information including a context identifier and a context authenticator; and
transmitting messages which include said context identifier and said context authenticator from said second peer to said first peer.

8. The method of claim 7 wherein said context identifier and said context authenticator are provided on at least one of the group comprising a per peer basis, a per Virtual Private Network (VPN) basis, a per peer per VPN basis, and a per peer next hop basis.

9. The method of claim 8 wherein said context identifier and said context authenticator are provided as one of the group comprising a label stack or a L2TPv3 header.

10. The method of claim 7 wherein said receiving routing information from a first peer comprises receiving routing information from a first Autonomous System Border Router (ASBR), and wherein said transmitting messages from said first peer to said second peer comprises transmitting messages from said first ASBR to said second ABSR.

11. A method of providing autonomous system interconnect comprising:
producing routing information at a first peer;
providing a context identifier in said routing information at said first peer;
providing a context authenticator in said routing information at said first peer;
advertising, from the first peer, said routing information to a second peer;
receiving routing information from the first peer at the second peer, said routing information including said context identifier and said context authenticator;
transmitting messages from said second peer which include said context identifier and said context authenticator to said first peer;
accepting, at said first peer, messages from said second peer which include said context identifier and said context authenticator.

12. The method of claim 11 further comprising dropping messages received from said second peer which do not include said context identifier and said context authenticator.

13. The method of claim 11 further comprising providing a virtual interface in said first peer, said virtual interface used for transmitting to and receiving from said second peer.

14. The method of claim 12 wherein said context identifier and said context authenticator are provided on at least one of the group comprising a per peer basis, a per Virtual Private Network (VPN) basis, a per peer per VPN basis, and a per peer next hop basis.

15. The method of claim 14 wherein said context identifier and said context authenticator are provided as one of the group comprising a label stack or a L2TPv3 header.

16. The method of claim 11 wherein said producing routing information at a first peer comprises producing routing information at a first Autonomous System Border Router (ASBR), and wherein said advertising, from said first peer, said routing information to a second peer comprises advertising, from said first ASBR, said routing information to a second ABSR.

17. A computer readable medium having computer readable code thereon for providing autonomous system interconnect, the medium comprising:
instructions for producing routing information at a first peer;
instructions for providing a context identifier in said routing information at said first peer;
instructions for providing a context authenticator in said routing information at said first peer;
instructions for advertising, from the first peer, said routing information to a second peer;
instructions for receiving routing information from the first peer at the second peer, said routing information including said context identifier and said context authenticator;
instructions for transmitting messages from said second peer which include said context identifier and said context authenticator to said first peer; and
instructions for accepting, at said first peer, messages from said second peer which include said context identifier and said context authenticator.

18. The computer readable medium of claim 17 further comprising instructions for dropping messages received from said second peer which do not include said context identifier and said context authenticator.

19. The computer readable medium of claim 17 further comprising instructions for providing a virtual interface in said first peer, said virtual interface used for transmitting to and receiving from said second peer.

20. The computer readable medium of claim 18 wherein said instructions for providing said context identifier and said context authenticator comprise instructions for providing said context identifier and said context authenticator on at least one of the group comprising a per peer basis, a per Virtual Private Network (VPN) basis, a per peer per VPN basis, and a per peer next hop basis.

21. The computer readable medium of claim 20 wherein said instructions for providing said context identifier and said context authenticator comprise instructions for providing said context identifier and said context authenticator as one of the group comprising a label stack or a L2TPv3 header.

22. The computer readable medium of claim 17 wherein said instructions for producing routing information at a first peer comprises instructions for producing routing information at a first Autonomous System Border Router (ASBR), and wherein said advertising, from said first peer, said routing information to a second peer comprises advertising, from said first ASBR, said routing information to a second ABSR.
